(19) United States
(12) Patent Application Publication
(10) Pub. No.: US 2019/0061765 A1
(43) Pub. Date: Feb. 28, 2019

(54) Systems and Methods for Performing Lane Changes Around Obstacles

(71) Applicant: Uber Technologies, Inc., San Francisco, CA (US)

(72) Inventors: Samuel Philip Marden, Pittsburgh, PA (US); Eric Michael Perko, Pittsburgh, PA (US)

(21) Appl. No.: 15/726,498

(22) Filed: Oct. 6, 2017

Related U.S. Application Data
(60) Provisional application No. 62/549,056, filed on Aug. 23, 2017.

(51) Int. Cl. B60W 30/18; G05D 1/00

(52) U.S. Cl. CPC B60W 30/18163; B60W 2550/30; B60W 2550/10; G05D 1/0088

(57) ABSTRACT

Systems and methods are directed to performing lane changes around a static or slow moving vehicle by an autonomous vehicle. In one example, a computer-implemented method for executing a lane change by an autonomous vehicle includes obtaining, by a computing system comprising one or more computing devices, an indication of an obstacle ahead of the autonomous vehicle in a current lane. The method further includes obtaining, by the computing system, an indication that the autonomous vehicle is likely to be queued behind the obstacle if staying in the current lane. The method further includes determining, by the computing system, that a lane change can be executed by the autonomous vehicle to move around the obstacle; and in response to determining that the lane change can be executed by the autonomous vehicle to move around the obstacle, generating a motion plan that executes the lane change.

This application claims the benefit of U.S. Provisional Application No. 62/549,056, filed Aug. 23, 2017.

### FIELD

The present disclosure relates generally to operation of an autonomous vehicle. More particularly, the present disclosure relates to systems and methods that provide for autonomous vehicle lane changes around an upcoming obstacle within the current travel lane of the autonomous vehicle.

### BACKGROUND

An autonomous vehicle is a vehicle that is capable of sensing its environment and navigating with little to no human input. In particular, an autonomous vehicle can observe its surrounding environment using a variety of sensors and can attempt to comprehend the environment by performing various processing techniques on data collected by the sensors. This can allow an autonomous vehicle to navigate without human intervention and, in some cases, even omit the use of a human driver altogether.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for executing a lane change by an autonomous vehicle. The method includes obtaining, by a computing system comprising one or more computing devices, an indication of an obstacle ahead of the autonomous vehicle in a current lane. The method further includes obtaining, by the computing system, an indication that the autonomous vehicle is likely to be queued behind the obstacle if staying in the current lane. The method further includes determining, by the computing system, that a lane change can be executed by the autonomous vehicle to move around the obstacle; and in response to determining that the lane change can be executed by the autonomous vehicle to move around the obstacle, generating a motion plan that executes the lane change.

Another example aspect of the present disclosure is directed to an autonomous vehicle. The autonomous vehicle includes a vehicle computing system. The vehicle computing system includes one or more processors; and one or more memories including instructions that, when executed by the one or more processors, cause the one or more processors to perform operations. The operations include obtaining an indication of an obstacle ahead of the autonomous vehicle in a current lane. The operations further include obtaining an indication that the autonomous vehicle is likely to be queued behind the obstacle if staying in the current lane. The operations further include determining that a lane change can be executed by the autonomous vehicle to move around the obstacle. The operations further include, in response to determining that the lane change can be executed by the autonomous vehicle to move around the obstacle, generating a motion plan that executes the lane change. The operations further include providing one or more control signals to one or more vehicle controls to implement the motion plan.

Another example aspect of the present disclosure is directed to a computing system. The computing system includes one or more processors and one or more memories including instructions that, when executed by the one or more processors, cause the one or more processors to perform operations. The operations include obtaining an indication of an obstacle ahead of the autonomous vehicle. The operations further include obtaining an indication that the autonomous vehicle is likely to be queued behind the obstacle if staying in the current lane. The operations further include determining that a lane change can be executed by the autonomous vehicle to move around the obstacle. The operations further include, in response to determining that the lane change can be executed by the autonomous vehicle to move around the obstacle, generating a motion plan that executes the lane change; and providing one or more control signals to implement the motion plan.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example system for controlling the navigation of an autonomous vehicle according to example embodiments of the present disclosure;

FIG. 2 depicts a block diagram of an example lane change scenario according to example embodiments of the present disclosure;

FIG. 3 depicts a flowchart diagram of example operations for a lane change around an obstacle according to example embodiments of the present disclosure;

FIG. 4 depicts a block diagram of example phases for a lane change according to example embodiments of the present disclosure;

FIG. 5 depicts a block diagram of an example computing system according to example embodiments of the present disclosure;

FIGS. 6A-6B depict block diagrams of example lane change timing for a lane change after an intersection according to example embodiments of the present disclosure;

FIGS. 7A-7B depict block diagrams of example lane change timing for a lane change after a curve according to example embodiments of the present disclosure; and

FIGS. 8A-8B depict block diagrams of example lane change timing for a lane change into an upcoming lane according to example embodiments of the present disclosure.

### DETAILED DESCRIPTION

Reference now will be made in detail to embodiments, one or more example(s) of which are illustrated in the drawings. Each example is provided by way of explanation of the embodiments, not limitation of the present disclosure. In fact, it will be apparent to those skilled in the art that various modifications and variations can be made to the embodiments without departing from the scope of the present disclosure. For instance, features illustrated or described as part of one embodiment can be used with another embodiment to yield a still further embodiment. Thus, it is intended that aspects of the present disclosure cover such modifications and variations.

Example aspects of the present disclosure are directed to calculating and executing autonomous vehicle lane changes around an upcoming obstacle, such as a parked or slow moving vehicle that is not expected to flow with traffic, within the current travel lane of the autonomous vehicle. In particular, the systems and methods of the present disclosure can determine and execute lane changes in situations where an autonomous vehicle is traveling in a desired lane but an obstacle, such as a parked or slow moving vehicle, a stopped delivery truck, a stopped bus, or the like, is blocking the travel lane and thus will prevent progress. The systems and methods of the present disclosure can provide for determining and executing a safe and viable lane change into an adjacent travel lane to move around the obstacle.

In particular, an autonomous vehicle may be traveling in a desired lane and a vehicle computing system may determine that a vehicle ahead of the autonomous vehicle in the lane is not expected to flow with traffic. For example, the vehicle ahead is stopped in the lane but is not at a red traffic light or stop sign, the vehicle ahead is moving slower than traffic would allow, or the like. The vehicle computing system may further determine whether there is not enough room to get around the vehicle without leaving the current lane boundaries, and thus the autonomous vehicle is likely to be queued behind the parked or slow moving vehicle if the autonomous vehicle remains in the current lane.

Accordingly, in some implementations, a vehicle computing system of the autonomous vehicle can analyze adjacent lanes (e.g., lanes having the same direction of travel) to determine if there is a safe and viable lane change that will allow the autonomous vehicle to move around the parked or slow moving vehicle. For example, the vehicle computing system can determine if there is enough room in front of and behind the autonomous vehicle in relation to one or more other vehicles in an adjacent lane for the autonomous vehicle to move into the adjacent lane safely and comfortably for the occupants of the autonomous vehicle (e.g., without making abrupt motions or requiring aggressive braking). The vehicle computing system can then plan and execute a plan to change lanes and move around the parked or slow moving vehicle.

Accordingly, in some implementations, a vehicle computing system of an autonomous vehicle can determine and execute appropriate lane changes around an obstacle (e.g., a static obstacle, slow moving obstacle, obstacle that is not expected to flow with traffic, etc.) in the current travel lane of the autonomous vehicle, such as a stopped vehicle, parked vehicle, slow moving vehicle, and/or the like. More particularly, an autonomous vehicle (e.g., a ground-based vehicle, air-based vehicle, other vehicle type) can include a variety of systems onboard the autonomous vehicle to control the operation of the vehicle. For instance, the autonomous vehicle can include one or more data acquisition systems (e.g., sensors, image capture devices), one or more vehicle computing systems (e.g. for providing autonomous operation), one or more vehicle control systems, (e.g., for controlling acceleration, braking, steering, etc.), and/or the like. The data acquisition system(s) can acquire sensor data (e.g., lidar data, radar data, image data, etc.) associated with one or more objects (e.g., pedestrians, vehicles, etc.) that are proximate to the autonomous vehicle and/or sensor data associated with the vehicle path (e.g., path shape, boundaries, markings, etc.). The sensor data can include information that describes the location (e.g., in three-dimensional space relative to the autonomous vehicle) of points that correspond to objects within the surrounding environment of the autonomous vehicle (e.g., at one or more times). The data acquisition system(s) can provide such sensor data to the vehicle computing system.

In addition to the sensor data, the vehicle computing system can obtain map data that provides other detailed information about the surrounding environment of the autonomous vehicle. For example, the map data can provide information regarding: the identity and location of various roadways, road segments, buildings, or other items; the location and direction of traffic lanes (e.g. the boundaries, location, direction, etc. of a travel lane, parking lane, a turning lane, a bicycle lane, and/or other lanes within a particular travel way); traffic control data (e.g., the location and instructions of signage, traffic signals, and/or other traffic control devices); and/or any other map data that provides information that can assist the autonomous vehicle in comprehending and perceiving its surrounding environment and its relationship thereto.

The vehicle computing system can include one or more computing devices and include various subsystems that can cooperate to perceive the surrounding environment of the autonomous vehicle and determine a motion plan for controlling the motion of the autonomous vehicle. For instance, the vehicle computing system can include a perception system, a prediction system, and a motion planning system. The vehicle computing system can receive and process the sensor data to generate an appropriate motion plan through the vehicle's surrounding environment.

The perception system can detect one or more objects that are proximate to the autonomous vehicle based on the sensor data. In particular, in some implementations, the perception system can determine, for each object, state data that describes a current state of such object. As examples, the state data for each object can describe an estimate of the object's: current location (also referred to as position); current speed/velocity; current acceleration; current heading; current orientation; size/footprint; class (e.g., vehicle class versus pedestrian class versus bicycle class, etc.); and/or other state information. In some implementations, the perception system can determine state data for each object over a number of iterations. In particular, the perception system can update the state data for each object at each iteration. Thus, the perception system can detect and track objects (e.g., vehicles, bicycles, pedestrians, etc.) that are proximate to the autonomous vehicle over time, and thereby produce a presentation of the world around an autonomous vehicle along with its state (e.g., a presentation of the objects within a scene at the current time along with the states of the objects).

In some implementations, the vehicle computing system (e.g., the perception system, etc.) can determine one or more features associated with the object based at least in part on the state data. In some implementations, the vehicle computing system can determine the feature(s) based at least in part on other information, such as the acquired map data. The feature(s) can be indicative of the movement (or lack thereof) and/or position of the object relative to items within the vehicle's surroundings and/or other information associated with the object. For example, the feature(s) can include a location of the object relative to a travel way (e.g., relative to the left or right lane markings), a location of the object relative to the autonomous vehicle (e.g., a distance between the current locations of the vehicle and the object), one or more characteristic(s) of the object relative to a travel route associated with the autonomous vehicle (e.g., whether the object is moving parallel, towards, or away from the vehicle's current/future travel route or a predicted point of intersection with the vehicle's travel route), etc. In some implementations, the feature(s) determined for a particular object may depend at least in part on the class of that object. For example, the predicted path for a vehicle or bicycle traveling on a roadway may be different than that associated with a pedestrian traveling on a sidewalk.

The prediction system can receive the state data from the perception system and predict one or more future locations for each object based on such state data. For example, the prediction system can predict where each object will be located within the next 5 seconds, 10 seconds, 20 seconds, etc. As one example, an object can be predicted to adhere to its current trajectory according to its current speed. As another example, other, more sophisticated prediction techniques or modeling can be used.

In some implementations, the vehicle computing system can determine a vehicle action for the autonomous vehicle based at least in part on the feature(s) associated with object. To do so, the autonomous vehicle can include, employ, and/or otherwise leverage a model, such as a machine-learned model. For instance, supervised training techniques can be performed to train the model (e.g., using driving log data) to determine a vehicle action based at least in part on the feature(s) associated with a an object. The vehicle computing system can input data indicative of at least the feature(s) into the machine-learned model and receive, as an output, data indicative of a recommended vehicle action. The recommended vehicle action can include stopping a motion of the autonomous vehicle for the object and/or queueing behind the object. For example, the output of the machine-learned model can indicate that the vehicle should stop for an object that is located in the center of the vehicle's current travel lane. As another example, the output at the machine-learned model can indicate that the vehicle should adjust its speed (e.g., to slow down) for a bicycle in the vehicle's current travel lane. In some implementations, the recommended vehicle action can include ignoring the object. For example, the output of the machine-learned model can indicate that the vehicle can maintain its current speed and/or trajectory, without adjusting for the object's presence (e.g., on a sidewalk). In some implementations, the recommended vehicle action can include moving the autonomous vehicle past the object. By way of example, the output of the machine-learned model can indicate that the vehicle can pass a pedestrian that is located at the side of the vehicle's current travel lane (e.g., waiting to cross the street).

The motion planning system can determine a motion plan for the autonomous vehicle based at least in part on predicted one or more future locations for the object provided by the prediction system and/or the state data for the object provided by the perception system. Stated differently, given information about the classification and current locations of objects and/or predicted future locations of proximate objects, the motion planning system can determine a motion plan for the autonomous vehicle that best navigates the autonomous vehicle along the determined travel route relative to the objects at such locations. In some implementations, the motion planning system can also consider one or more recommended vehicle actions (e.g., pass, ignore, queue) in regard to objects in the surrounding environment in determining a a motion plan for the autonomous vehicle.

As one example, in some implementations, the motion planning system can determine a cost function for each of one or more candidate motion plans for the autonomous vehicle based at least in part on the current locations and/or predicted future locations of the objects. For example, the cost function can describe a cost (e.g., over time) of adhering to a particular candidate motion plan. For example, the cost described by a cost function can increase when the autonomous vehicle approaches impact with another object and/or deviates from a preferred pathway (e.g., a predetermined travel route).

Thus, given information about the classifications, current locations, and/or predicted future locations of objects, the motion planning system can determine a cost of adhering to a particular candidate pathway. The motion planning system can select or determine a motion plan for the autonomous vehicle based at least in part on the cost function(s). For example, the motion plan that minimizes the cost function can be selected or otherwise determined. The motion planning system then can provide the selected motion plan to a vehicle controller that controls one or more vehicle controls (e.g., actuators or other devices that control acceleration, steering, braking, etc.) to execute the selected motion plan.

More particularly, in some implementations, the perception system and/or prediction system can determine that an upcoming object (e.g., car, delivery truck, bus, other vehicle, etc.) in the travel lane is stopped, parked, or moving slowly and is not expected to flow with traffic. For example, the prediction system can output prediction data that indicates that an object in the lane ahead is stopped or moving slowly due to reasons other than a traffic control device or traffic ahead of the vehicle (e.g., traffic signals ahead of the vehicle are green, there is no traffic ahead of the vehicle, and the road is clear, etc.). In some implementations, the prediction system may provide an object classification for a vehicle, such as a stopped or slow moving vehicle that indicates that it is an obstacle. Additionally, the object classification may further indicate that an obstacle such as stopped vehicle is a static object. The prediction system output may be provided to the motion panning system for analysis.

In some implementations, the motion planning system can determine the manner in which the autonomous vehicle may need to respond to an obstacle, such as a parked vehicle. For example, the motion planning system can determine that there is not enough space within the current lane boundaries for the autonomous vehicle to move past the parked vehicle (e.g., static obstacle in the current lane). Thus, if the autonomous vehicle is to remain within the current lane boundaries, the autonomous vehicle may have to queue behind the parked vehicle (e.g., stop and wait for the parked vehicle to resume travel).

In some implementations, based on a determination that an upcoming object (e.g., vehicle) is not expected to flow with traffic (e.g., an obstacle) and that the autonomous vehicle will not be able to pass the upcoming object while staying within the lane boundaries, the vehicle computing system (e.g., the motion planning system) can analyze adjacent lanes in the same direction of travel to determine whether the autonomous vehicle can safely and comfortably execute a lane change to an adjacent lane to move around the obstacle (e.g., stopped or slow moving vehicle).

For example, in some implementations, a vehicle computing system (e.g., the prediction system, the motion planning system, etc.) can provide an object classification including an indication of whether an object can be safely passed by the autonomous vehicle, ignored by the autonomous vehicle, or will likely cause the autonomous vehicle to queue behind the object at least in part based on an assumption that the autonomous vehicle will remain within the current lane boundaries. Such a classification of pass, ignore, or queue can be provided as input for a determination of whether a lane change should be executed by the autonomous vehicle, for example, where a queue classification can initiate an analysis of adjacent lanes in the same direction of travel to determine whether the autonomous vehicle can safely and comfortably execute a lane change.

In particular, according to an aspect of the present disclosure, the vehicle computing system can initiate a lane change process to determine if the autonomous vehicle can execute a lane change to progress around the stopped or slow moving vehicle. For example, in some implementations, the vehicle computing system can use sensor data to observe all the objects around the autonomous vehicle including vehicles in adjacent lanes that the autonomous vehicle could potentially move into. The vehicle computing system can determine predictions/estimations of where the objects will be in the next 5 seconds, 10 seconds, or the like. The vehicle computing system can then determine whether there is enough space in front of and behind the autonomous vehicle if it were to move into the adjacent lane to safely and comfortably complete the move into the adjacent lane.

In some implementations, the vehicle computing system may consider other sensor data or other inputs in addition to object perception and/or predictions/estimations from the prediction object outputs when determining whether a safe lane change can be executed. For example, other sensors or data input may provide information regarding the free space around an autonomous vehicle that may be considered in the determination of whether a lane change can be safely executed to move around an obstacle, such as a parked or slow moving vehicle.

According to another aspect of the disclosure, in some implementations, the determination of a safe and comfortable lane change involves analyzing the aggressiveness of the response and a time to collision measure in addition to distances to objects in the adjacent lane. To achieve improved safety and comfort of the vehicle occupants, the vehicle computing system may avoid a lane change that might cause too aggressive a response from the autonomous vehicle or other surrounding vehicles when making a lane change. For example, if an adjacent lane has enough space for the vehicle to make a lane change (e.g., would avoid a collision with another vehicle) but the lane change would require the autonomous vehicle to brake too hard (e.g., exceeding a deceleration threshold), the lane change may not be a viable option. As another example, the vehicle computing system may determine that a vehicle in an adjacent lane is well behind the autonomous vehicle such that there is enough space to make the lane change, but the approaching vehicle is traveling very fast (e.g., exceeding a speed threshold), the lane change may not be executed because it may cause the approaching vehicle to brake too hard to allow the autonomous vehicle enough space to complete the lane change. In such a scenario, the autonomous vehicle may remain in the current lane and wait for a future opportunity to make the lane change. For example, the autonomous vehicle may let the approaching vehicle pass and then determine if it would be safe to change lanes after the vehicle has passed.

According to another aspect of the disclosure, in some implementations, the vehicle computing system may consider a number of defined rules or heuristics when determining whether to execute a lane change to move around an obstacle, such as a parked or slow moving vehicle. For example, in some implementations, the vehicle computing system may determine that a lane change can be executed if moving to the adjacent lane would be better for achieving the route plan goal than queuing behind a stopped vehicle. In some implementations, the vehicle computing system may determine that a lane change can be executed only if the autonomous vehicle is greater than a defined distance from an upcoming intersection. In some implementations, the vehicle computing system may determine that a lane change can be executed if there is at least a defined minimum amount of open space ahead of and behind the autonomous vehicle in the adjacent lane. Various combinations of these rules and heuristics can be used as well.

In some implementations, the analysis of whether to make a lane change around a stopped or slow moving vehicle may include determining that the lane change would not negatively impact the autonomous vehicle progress. For example, if the autonomous vehicle's route goes through an upcoming intersection and the only adjacent lane available to make a lane change would be a left turn lane, the autonomous vehicle may avoid making the lane change so as not to get stuck in a left turn that would negatively impact the route plan goal. In such situations, the vehicle computing system may additionally consider the route plan goal in determining whether there is a viable lane change to move around a stopped or slow moving vehicle.

According to another aspect of the disclosure, in some implementations, the vehicle computing system can determine whether the autonomous vehicle should return to the original lane after passing the stopped or slow moving vehicle. For example, before passing the stopped or slow moving vehicle, the vehicle computing system can perform a lane change analysis to determine whether the autonomous vehicle should return to the original lane (e.g., a right turn planned using the original lane). If the vehicle computing system determines that the autonomous vehicle should return to the original lane, the vehicle computing system can determine whether the autonomous vehicle could return to the original lane after the lane change (e.g., there is enough space in the original lane for the autonomous vehicle to return to the original lane after passing the obstacle). If the vehicle computing system determines that the autonomous vehicle could return to the original lane after the lane change, the autonomous vehicle determines whether the autonomous vehicle could make the lane change to the adjacent lane. As another example, after passing the stopped or slow moving vehicle, the vehicle computing system can perform a similar lane change analysis to determine whether the autonomous vehicle should return to the original lane. In some implementations, the vehicle computing system may determine whether it would be safe to make a lane change back to the original lane. The vehicle computing system may also determine whether it would be advantageous to the route plan goal to change back into the original lane. For example, if the vehicle computing system determines that moving back into the original lane might cause the autonomous vehicle to encounter another obstacle (e.g., parked vehicle), it may determine that a lane change back to the original lane should not be executed.

According to another aspect of the disclosure, in some implementations, the lane change analysis can involve the use of one or more machine-learned models. For example, rather than a rules-based analysis, the vehicle computing system may provide the input data to a machine-learned model which may output a prediction of whether a lane change scenario should be executed or not. In some implementations, the machine-learned model can consider how the autonomous vehicle would occupy the other lane space with respect to other vehicles in the determination of whether to execute a lane change scenario. In some implementations, a machine-learned model output can provide a ranking of the options for a lane change scenario. For example, if there is a vehicle in the lane adjacent to the autonomous vehicle and it would be safe to either move in front of or behind the vehicle in the adjacent lane, the machine-learned model output could rank the options to allow for an optimal lance change execution.

According to another aspect of the present disclosure, in some implementations, the vehicle computing system may begin a lane change plan before the autonomous vehicle is adjacent to the intended or target lane change area. For example, the vehicle computing system may begin the first phase of a lane change process while the autonomous vehicle is approaching the target area where a lane change will occur and before the autonomous vehicle actually is adjacent to the target lane area that the autonomous vehicle will move into, such as where the autonomous vehicle will change lanes after crossing an intersection, after making a turn, or into a new upcoming lane. In such situations, by initiating the lane change plan prior to being adjacent to the intended lane change area, the vehicle computing system can implement smoother lane changes that improve vehicle safety and the comfort level of the vehicle occupants.

As an example, the upcoming route plan of an autonomous vehicle may include changing lanes after the vehicle has crossed through an upcoming intersection. In some implementations, the vehicle computing system may initiate the lane change plan (e.g., the first phase of the lane change) while the autonomous vehicle is in the intersection as opposed to initiating the lane change process only after crossing through the intersection, such that the autonomous vehicle may make the lane change more smoothly after crossing through the intersection.

As another example, the upcoming route plan of an autonomous vehicle may include changing lanes after the vehicle has completed an upcoming turn. In some implementations, the vehicle computing system may initiate the lane change plan (e.g., the first phase of the lane change) while the autonomous vehicle is in the turn as opposed to initiating the lane change process only after completing the turn, such that the autonomous vehicle may make the lane change more smoothly after completing the turn.

As another example, the upcoming route plan of an autonomous vehicle may include changing lanes into an upcoming lane (e.g., a new lane that starts ahead of the current vehicle position). In some implementations, the vehicle computing system may initiate the lane change plan (e.g., the first phase of the lane change) before the autonomous vehicle is adjacent to the upcoming new lane as opposed to waiting to initiate the lane change process until after the vehicle is adjacent to the new lane, such that the autonomous vehicle may make the lane change more smoothly upon being next to the new lane.

The systems and methods described herein provide a number of technical effects and benefits. For instance, the vehicle computing system can locally (e.g., on board the autonomous vehicle) detect upcoming obstacles, evaluate lane changes, and adjust the route of the autonomous vehicle accordingly. By performing such operations onboard the autonomous vehicle, the vehicle computing system can avoid latency issues that arise from communicating with a remote computing system. The vehicle computing system can be configured to perform this process as the autonomous vehicle travels a planned route to optimize vehicle efficiency and travel time. As such, the vehicle computing system can proactively adjust the route of the autonomous vehicle to reduce unnecessary stops or slowdowns and achieve improved driving safety.

The systems and methods described herein can also provide resulting improvements to vehicle computing technology tasked with operation of an autonomous vehicle. For example, aspects of the present disclosure can enable a vehicle computing system to more efficiently and accurately control an autonomous vehicle's route by allowing for lane changes around obstacles and smoother travel lane changes based on the analysis of context along a route. As another example, the systems and methods described herein can prevent an autonomous vehicle from queueing unnecessarily behind an obstacle (e.g., stopped or slow moving object), thereby improving the efficiency and energy consumption of the autonomous vehicle.

With reference to the figures, example embodiments of the present disclosure will be discussed in further detail.

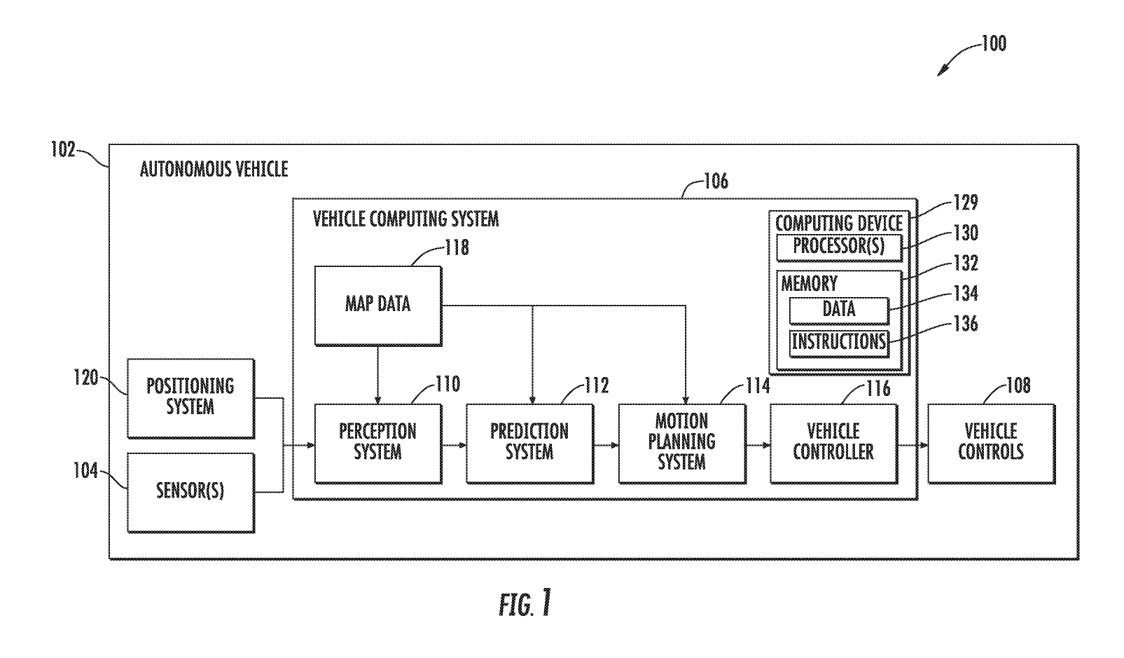

FIG. 1 depicts a block diagram of an example system 100 for controlling the navigation of an autonomous vehicle 102 according to example embodiments of the present disclosure. The autonomous vehicle 102 is capable of sensing its environment and navigating with little to no human input. The autonomous vehicle 102 can be a ground-based autonomous vehicle (e.g., car, truck, bus, etc.), an air-based autonomous vehicle (e.g., airplane, drone, helicopter, or other aircraft), or other types of vehicles (e.g., watercraft). The autonomous vehicle 102 can be configured to operate in one or more modes, for example, a fully autonomous operational mode and/or a semi-autonomous operational mode. A fully autonomous (e.g., self-driving) operational mode can be one in which the autonomous vehicle can provide driving and navigational operation with minimal and/or no interaction from a human driver present in the vehicle. A semi-autonomous (e.g., driver-assisted) operational mode can be one in which the autonomous vehicle operates with some interaction from a human driver present in the vehicle.

The autonomous vehicle 102 can include one or more sensors 104, a vehicle computing system 106, and one or more vehicle controls 108. The vehicle computing system 106 can assist in controlling the autonomous vehicle 102. In particular, the vehicle computing system 106 can receive sensor data from the one or more sensors 104, attempt to comprehend the surrounding environment by performing various processing techniques on data collected by the sensors 104, and generate an appropriate motion path through such surrounding environment. The vehicle computing system 106 can control the one or more vehicle controls 108 to operate the autonomous vehicle 102 according to the motion path.

The vehicle computing system 106 can include one or more processors 130 and at least one memory 132. The one or more processors 130 can be any suitable processing device (e.g., a processor core, a microprocessor, an ASIC, a FPGA, a controller, a microcontroller, etc.) and can be one processor or a plurality of processors that are operatively connected. The memory 132 can include one or more non-transitory computer-readable storage mediums, such as RAM, ROM, EEPROM, EPROM, flash memory devices, magnetic disks, etc., and combinations thereof. The memory 132 can store data 134 and instructions 136 which are executed by the processor 130 to cause vehicle computing system 106 to perform operations. In some implementations, the one or more processors 130 and at least one memory 132 may be comprised in one or more computing devices, such as computing device(s) 129, within the vehicle computing system 106.

In some implementations, vehicle computing system 106 can further be connected to, or include, a positioning system 120. Positioning system 120 can determine a current geographic location of the autonomous vehicle 102. The positioning system 120 can be any device or circuitry for analyzing the position of the autonomous vehicle 102. For example, the positioning system 120 can determine actual or relative position by using a satellite navigation positioning system (e.g. a GPS system, a Galileo positioning system, the GLObal Navigation satellite system (GLONASS), the BeiDou Satellite Navigation and Positioning system), an inertial navigation system, a dead reckoning system, based on IP address, by using triangulation and/or proximity to cellular towers or WiFi hotspots, and/or other suitable techniques for determining position. The position of the autonomous vehicle 102 can be used by various systems of the vehicle computing system 106.

As illustrated in FIG. 1, in some embodiments, the vehicle computing system 106 can include a perception system 110, a prediction system 112, and a motion planning system 114 that cooperate to perceive the surrounding environment of the autonomous vehicle 102 and determine a motion plan for controlling the motion of the autonomous vehicle 102 accordingly.

In particular, in some implementations, the perception system 110 can receive sensor data from the one or more sensors 104 that are coupled to or otherwise included within the autonomous vehicle 102. As examples, the one or more sensors 104 can include a Light Detection and Ranging (LIDAR) system, a Radio Detection and Ranging (RADAR) system, one or more cameras (e.g., visible spectrum cameras, infrared cameras, etc.), and/or other sensors. The sensor data can include information that describes the location of objects within the surrounding environment of the autonomous vehicle 102.

As one example, for LIDAR system, the sensor data can include the location (e.g., in three-dimensional space relative to the LIDAR system) of a number of points that correspond to objects that have reflected a ranging laser. For example, LIDAR system can measure distances by measuring the Time of Flight (TOF) that it takes a short laser pulse to travel from the sensor to an object and back, calculating the distance from the known speed of light.

As another example, for RADAR system, the sensor data can include the location (e.g., in three-dimensional space relative to RADAR system) of a number of points that correspond to objects that have reflected a ranging radio wave. For example, radio waves (pulsed or continuous) transmitted by the RADAR system can reflect off an object and return to a receiver of the RADAR system, giving information about the object's location and speed. Thus, RADAR system can provide useful information about the current speed of an object.

As yet another example, for one or more cameras, various processing techniques (e.g., range imaging techniques such as, for example, structure from motion, structured light, stereo triangulation, and/or other techniques) can be performed to identify the location (e.g., in three-dimensional space relative to the one or more cameras) of a number of points that correspond to objects that are depicted in imagery captured by the one or more cameras. Other sensor systems can identify the location of points that correspond to objects as well.

Thus, the one or more sensors 104 can be used to collect sensor data that includes information that describes the location (e.g., in three-dimensional space relative to the autonomous vehicle 102) of points that correspond to objects within the surrounding environment of the autonomous vehicle 102.

In addition to the sensor data, the perception system 110 can retrieve or otherwise obtain map data 118 that provides detailed information about the surrounding environment of the autonomous vehicle 102. The map data 118 can provide information regarding: the identity and location of different travelways (e.g., roadways), road segments, buildings, or other items or objects (e.g., lampposts, crosswalks, curbing, etc.); the location and directions of traffic lanes (e.g., the location and direction of a parking lane, a turning lane, a bicycle lane, or other lanes within a particular roadway or other travelway); traffic control data (e.g., the location and instructions of signage, traffic lights, or other traffic control devices); and/or any other map data that provides information that assists the vehicle computing system 106 in comprehending and perceiving its surrounding environment and its relationship thereto.

The perception system 110 can identify one or more objects that are proximate to the autonomous vehicle 102 based on sensor data received from the one or more sensors 104 and/or the map data 118. In particular, in some implementations, the perception system 110 can determine, for each object, state data that describes a current state of such object. As examples, the state data for each object can describe an estimate of the object's: current location (also referred to as position); current speed; current heading (also referred to together as velocity); current acceleration; current orientation; size/footprint (e.g., as represented by a bounding shape such as a bounding polygon or polyhedron); class (e.g., vehicle versus pedestrian versus bicycle versus other); yaw rate; and/or other state information.

In some implementations, the perception system 110 can determine state data for each object over a number of iterations. In particular, the perception system 110 can update the state data for each object at each iteration. Thus, the perception system 110 can detect and track objects (e.g., vehicles, pedestrians, bicycles, and the like) that are proximate to the autonomous vehicle 102 over time.

The prediction system 112 can receive the state data from the perception system 110 and predict one or more future locations for each object based on such state data. For example, the prediction system 112 can predict where each object will be located within the next 5 seconds, 10 seconds, 20 seconds, etc. As one example, an object can be predicted to adhere to its current trajectory according to its current speed. As another example, other, more sophisticated prediction techniques or modeling can be used.

In some implementations, the vehicle computing system (e.g., the perception system 110, the prediction system 112, etc.) can include a feature extractor that extracts one or more features associated with an object. The feature(s) can be indicative of the movement (or lack thereof) and/or position of an object (e.g., pedestrian, vehicle, other object, etc.) relative to items within the vehicle's surroundings and/or other information associated with the object. The object can be, for example, a pedestrian that is traveling on a sidewalk adjacent to the vehicle's current travel way (e.g., road), a vehicle within the vehicle's current travel way (e.g., ahead of the vehicle in the lane of travel), a bicycle, and/or other object positioned in/near or traveling in a travel way.

In some implementations, the feature(s) can include one or more general features. For example, the general features associated with the object can include a speed/velocity of the object, a radius/size/footprint associated with the object, a heading of the object, a speed of the vehicle 102 to which the object is proximately located, etc. Additionally, or alternatively, the feature(s) can include one or more predicted future locations and/or a predicted travel path associated with the object. At least a portion of these feature(s) can be determined based on the state data.

In some implementations, the feature(s) can include one or more map-related features. For example, the features associated with the object can include a location of the object relative to a travelway, a distance between the object from the travelway boundaries and/or markings, a width of the largest gap between the object and a travelway boundary, distance from a cross walk, etc. The map-related features can be determined based at least in part on one or more of the state data and the map data.

In some implementations, the feature(s) can include one or more vehicle-related features. The vehicle-related feature(s) can be indicative of one or more characteristics of the object relative to the vehicle 102 and/or a vehicle travel route (e.g., current, intended, future planned trajectory) associated with the vehicle 102. For example, the vehicle-related feature(s) can include a relative heading of the object to the vehicle 102, a distance between the object and the vehicle 102, etc. In some implementations, the feature extractor can identify a point on the vehicle travel route that is closest to the object. The point can be updated over time as the vehicle 102 and/or the object change location. The vehicle-related feature(s) can include, for example, the distance between the object and the point, the distance between the vehicle 102 and the point, the heading of the object relative to the point, the speed of the object relative to the point, the amount and/or percentage of braking force needed to cause the vehicle 102 to reach a stopped position before the point, etc. In some implementations, the feature extractor can identify a potential intersection point between the vehicle 102 (e.g., based at least in part on a vehicle travel route associated therewith) and the object (e.g., based at least in part on a predicted location and/or predicted travel path associated therewith). The vehicle-related feature(s) can include, for example, a distance between the object and the potential intersection point, an estimated time at which the object is to reach the potential intersection point, a distance between the vehicle 102 and the potential intersection point, an estimated time at which the vehicle 102 is to reach the potential intersection point, etc.

In some implementations, the feature(s) determined for the object may depend on the class of the object. For example, the vehicle computing system 106 (e.g., the perception system 110, etc.) can select an object class for the object from a plurality of candidate object classes, which can include, for instance, at least one of a pedestrian class, a vehicle class, and a bicycle class. The vehicle computing system 106 can determine the one or more features associated with the object based at least in part on the object class for the object. For example, the predicted path for a vehicle or bicycle traveling on a roadway may be different than that associated with a pedestrian traveling on a sidewalk.

In some implementations, the vehicle computing system 106 (e.g., a pass/ignore/queue classifier, etc.) can determine a recommended vehicle action for the vehicle 102 based at least in part on the feature(s) associated with the object (e.g., pedestrian, vehicle, etc.). To do so, the vehicle computing system 106 can include, employ, and/or otherwise leverage a model, such as a machine-learned model. For instance, supervised training techniques can be performed to train the model (e.g., using driving log data) to determine a vehicle action based at least in part on the feature(s) associated with the object (e.g., pedestrian, vehicle, or other object). In some implementations, the vehicle action can include queueing the vehicle 102 behind the object when planning the motion of the vehicle 102. In some implementations, the vehicle action can include ignoring the object when planning the motion of the vehicle 102. In some implementations, the vehicle action can include moving the vehicle 102 past the object.

The motion planning system 114 can determine a motion plan for the autonomous vehicle 102 based at least in part on the predicted one or more future locations for the object provided by the prediction system 112 and/or the state data for the object provided by the perception system 110. Stated differently, given information about the current locations of objects and/or predicted future locations of proximate objects, the motion planning system 114 can determine a motion plan for the autonomous vehicle 102 that best navigates the autonomous vehicle 102 relative to the objects at such locations. In some implementations, the motion planning system 114 can also consider one or more recommended vehicle actions (e.g., pass, ignore, queue classification) in regard to objects in the surrounding environment in determining a motion plan for the autonomous vehicle. Additionally, the motion planning system 114 can perform the operations to plan and execute a lane change around an obstacle (e.g., stopped or slow moving object, etc.), as described herein.

As one example, in some implementations, the motion planning system 114 can determine a cost function for each of one or more candidate motion plans for the autonomous vehicle 102 based at least in part on the current locations and/or predicted future locations of the objects. For example, the cost function can describe a cost (e.g., over time) of adhering to a particular candidate motion plan. For example, the cost described by a cost function can increase when the autonomous vehicle 102 approaches a possible impact with another object and/or deviates from a preferred pathway (e.g., a preapproved pathway).

Thus, given information about the current locations and/or predicted future locations of objects, the motion planning system 114 can determine a cost of adhering to a particular candidate pathway. The motion planning system 114 can select or determine a motion plan for the autonomous vehicle 102 based at least in part on the cost function(s). For example, the candidate motion plan that minimizes the cost function can be selected or otherwise determined. The motion planning system 114 can provide the selected motion plan to a vehicle controller 116 that controls one or more vehicle controls 108 (e.g., actuators or other devices that control gas flow, acceleration, steering, braking, etc.) to execute the selected motion plan.

Additionally, in some implementations, the perception system 110 and/or the prediction system 112 can provide object classifications that include classifying an upcoming object as an obstacle (e.g., a static or slow moving object, such as a stopped vehicle, etc.). The prediction system 112 and/or the motion planning system 114 can include a pass/ignore/queue classifier that can receive the object classification and provide an indication of whether an object can be safely passed by the autonomous vehicle, ignored by the autonomous vehicle, or will likely cause the autonomous vehicle to queue behind the object at least in part based on an assumption that the autonomous vehicle will remain within the current lane boundaries. The motion planning system 114 can obtain these as input into a determination of whether a lane change can be executed to move around an obstacle, as described herein.

Each of the perception system 110, the prediction system 112, the motion planning system 114, and the vehicle controller 116 can include computer logic utilized to provide desired functionality. In some implementations, each of the perception system 110, the prediction system 112, the motion planning system 114, and the vehicle controller 116 can be implemented in hardware, firmware, and/or software controlling a general purpose processor. For example, in some implementations, each of the perception system 110, the prediction system 112, the motion planning system 114, and the vehicle controller 116 includes program files stored on a storage device, loaded into a memory, and executed by one or more processors. In other implementations, each of the perception system 110, the prediction system 112, the motion planning system 114, and the vehicle controller 116 includes one or more sets of computer-executable instructions that are stored in a tangible computer-readable storage medium such as RAM hard disk or optical or magnetic media.

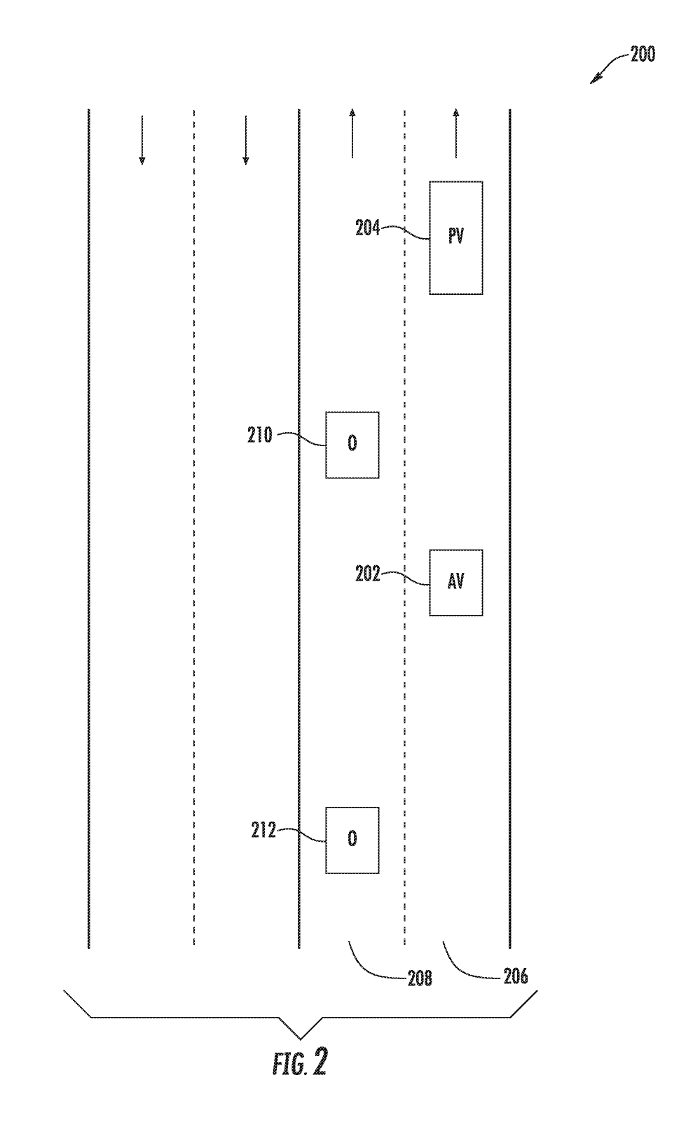

FIG. 2 depicts a block diagram of an example lane change scenario 200 according to example embodiments of the present disclosure. For example, an autonomous vehicle 202 may be traveling in a desired lane 206 and may determine that a vehicle 204 ahead of the autonomous vehicle in the lane 206 is not expected to flow with traffic. For example, the vehicle 204 may be stopped in the lane 206 but is not at a red traffic light or stop sign (e.g., may be temporarily stopped at an arbitrary point in the travel lane). As another example, the vehicle 204 may be moving slowly in the lane 206 with no traffic ahead of the vehicle 204. The autonomous vehicle 202 (e.g., the vehicle computing system) may further determine there is not enough room to get around the vehicle 204 without leaving the current lane 206 boundaries, and thus the autonomous vehicle 202 is likely to be queued behind the vehicle 204 if it remains in the lane 206.

Accordingly, the autonomous vehicle 202 (e.g., the vehicle computing system) can analyze adjacent lane(s) 208 to determine if there is a safe and viable lane change that will allow the autonomous vehicle 202 to move around the vehicle 204. For example, the autonomous vehicle 202 can determine if there is enough room in front of and behind the autonomous vehicle 202 in relation to one or more other vehicles, such as vehicle 210 and vehicle 212, in an adjacent lane 208 for the autonomous vehicle 202 to move into the adjacent lane 208 safely and comfortably for the occupants of the autonomous vehicle 202.

FIG. 3 depicts a flowchart diagram of example operations 300 for a lane change around an obstacle (e.g., a parked/stopped vehicle, slow moving vehicle, etc.) according to example embodiments of the present disclosure. One or more portion(s) of the operations 300 can be implemented by one or more computing devices such as, for example, the vehicle computing system 106 of FIG. 1, the computing system 106 of FIG. 5, or the like. Moreover, one or more portion(s) of the operations 300 can be implemented as an algorithm on the hardware components of the device(s) described herein (e.g., as in FIGS. 1 and 5) to, for example, provide for safe lane changes around static obstacles during autonomous vehicle operation.

At 302, one or more computing devices included within a computing system (e.g., vehicle computing system 106 or the like) can obtain an indication that there is an upcoming obstacle (e.g., parked/stopped vehicle, slow moving vehicle, etc.) in the travel lane ahead of an autonomous vehicle. For instance, a computing system (e.g., an autonomous vehicle computing system) can obtain information, such as sensor and/or map data, regarding the context around the autonomous vehicle and determine that an object in the lane ahead is stopped or moving slowly due to reasons other than a traffic control device or traffic ahead of the stopped or slow moving vehicle.

At 304, the computing system can obtain an indication that the obstacle is likely to cause the autonomous vehicle to be queued behind the obstacle if the autonomous vehicle remains within the boundaries of the current travel lane. For example, the computing system can determine that there is not enough space within the current travel lane boundaries for the autonomous vehicle to move past the obstacle. Thus, if the autonomous vehicle is to remain within the current travel lane boundaries, the autonomous vehicle may have to come to a stop or slow down behind the obstacle and wait for it to resume travel.

At 306, the computing system can determine whether there is a viable lane change into an adjacent lane. For example, the computing system can use sensor data to observe objects around the autonomous vehicle including one or more vehicles in one or more adjacent lanes that the autonomous vehicle could potentially move into. The computing system can determine predictions/estimations of where the objects in adjacent lanes will be in the next 5 seconds, 10 seconds, or the like. The computing system can then determine whether there is enough space in front of and behind the autonomous vehicle if it were to move into the adjacent lane to safely and comfortably complete a move into the adjacent lane to pass around the obstacle.

At 308, the computing system can determine whether to proceed with a lane change into an adjacent lane. If the lane change can be safely and comfortably executed, operation proceeds to 310. If there is not a viable lane change to an adjacent lane at the present moment, operation can return to 306 and wait to determine viability of a lane change to an adjacent lane at a future moment (for example, after a vehicle that is too close in an adjacent lane has passed the autonomous vehicle).

At 310, the computing system can determine one or more changes to a motion plan to execute the lane change into the adjacent lane. At 312, the computing system can provide commands to execute the lane change, for example, by providing one or more control signals to one or more vehicle controls to execute the lane change into the adjacent lane.

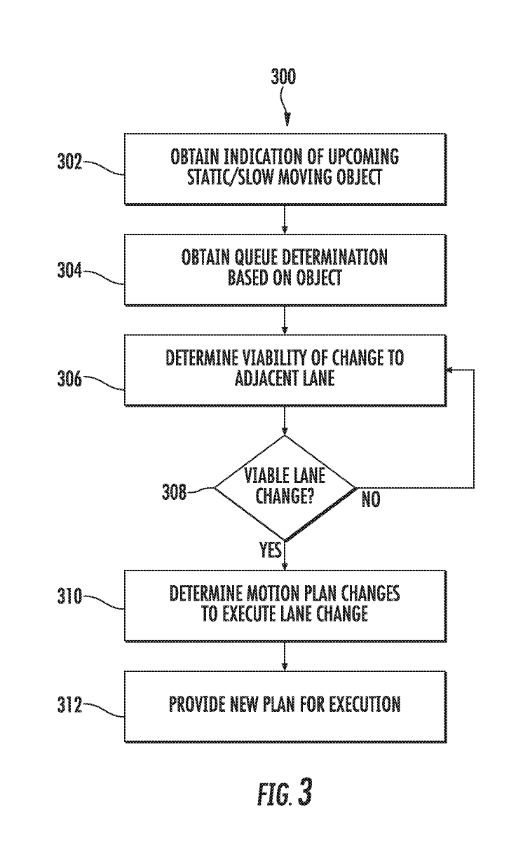

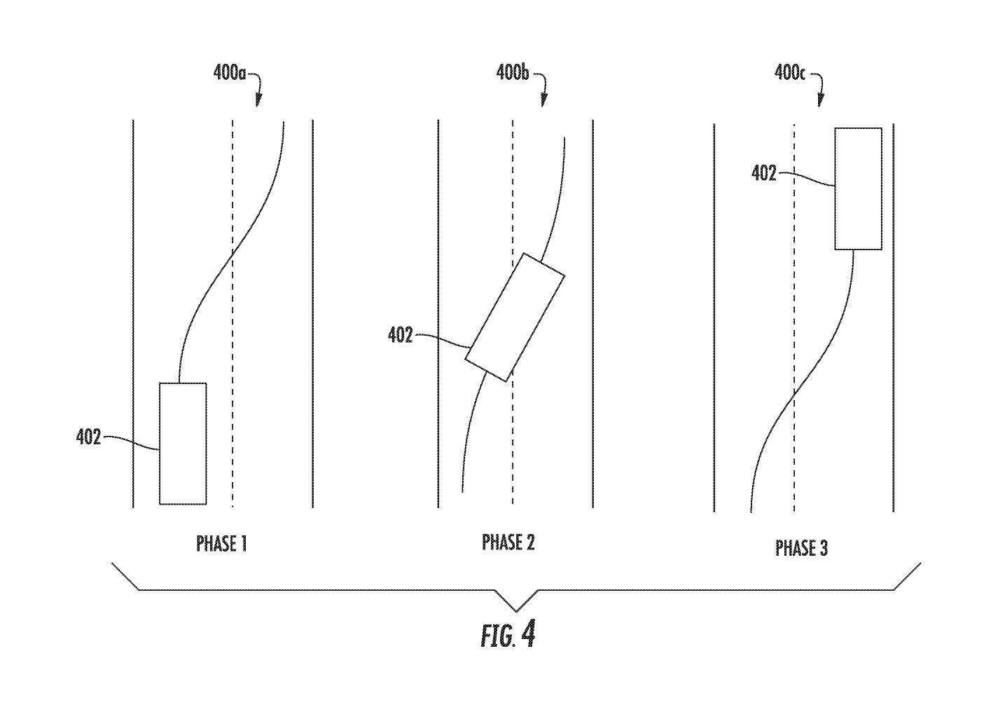

FIG. 4 depicts a block diagram of example phases 400a-400c for a lane change according to example embodiments of the present disclosure. In some implementations, the performance of a lane change for an autonomous vehicle may occur in a number of phases. For example, as illustrated in FIG. 4, the performance of an autonomous vehicle lane change according to example embodiments may be divided into three phases. The first phase 400a of a lane change may be initiated once the autonomous vehicle 402 determines that a safe lane change can be executed. During the first phase 400a, the autonomous vehicle 402 is positioned within the current or starting lane and operations to perform the lane change are initiated. During the second phase 400b of the lane change, the autonomous vehicle 402 moves out of the starting lane and crosses the lane marker beginning to move into the adjacent (target) lane. During the third phase 400c of the lane change, the autonomous vehicle 402 completes the move into the target lane and proceeds within the boundaries of the target lane. During the three phases of the lane change, the autonomous vehicle 402 may continuously monitor the environment around the autonomous vehicle to ensure that the lane change is executed safely and may make changes to the execution of the lane change accordingly.

FIG. 5 depicts a block diagram of an example computing system 500 according to example embodiments of the present disclosure. The example computing system 500 illustrated in FIG. 5 is provided as an example only. The components, systems, connections, and/or other aspects illustrated in FIG. 5 are optional and are provided as examples of what is possible, but not required, to implement the present disclosure. The example computing system 500 can include the vehicle computing system 106 of the autonomous vehicle 102 and, in some implementations, a remote computing system 510 including remote computing device(s) that is remote from the autonomous vehicle 102 (e.g., an operations computing system) that can be communicatively coupled to one another over one or more networks 520. The remote computing system 510 can be associated with a central operations system and/or an entity associated with the autonomous vehicle 102 such as, for example, a vehicle owner, vehicle manager, fleet operator, service provider, etc.

The computing device(s) 129 of the vehicle computing system 106 can include processor(s) 502 and a memory 504. The one or more processors 502 can be any suitable processing device (e.g., a processor core, a microprocessor, an ASIC, a FPGA, a controller, a microcontroller, etc.) and can be one processor or a plurality of processors that are operatively connected. The memory 504 can include one or more non-transitory computer-readable storage media, such as RAM, ROM, EEPROM, EPROM, one or more memory devices, flash memory devices, etc., and combinations thereof.

The memory 504 can store information that can be accessed by the one or more processors 502. For instance, the memory 504 (e.g., one or more non-transitory computer-readable storage mediums, memory devices) on-board the autonomous vehicle 102 can include computer-readable instructions 506 can be executed by the one or more processors 502. The instructions 506 can be software written in any suitable programming language or can be implemented in hardware. Additionally, or alternatively, the instructions 506 can be executed in logically and/or virtually separate threads on processor(s) 502.

For example, the memory 504 on-board the autonomous vehicle 102 can store instructions 506 that when executed by the one or more processors 502 on-board the autonomous vehicle 102 cause the one or more processors 502 (the vehicle computing system 106) to perform operations such as any of the operations and functions of the computing device(s) 129 or for which the computing device(s) 129 are configured, as described herein including, for example, operations of FIG. 3.

The memory 504 can store data 508 that can be obtained, received, accessed, written, manipulated, created, and/or stored. The data 508 can include, for instance, sensor data, map data, data identifying detected objects including current object states and predicted object locations and/or trajectories, service request data (e.g., trip and/or user data), motion plans, etc., as described herein. In some implementations, the computing device(s) 129 can obtain data from one or more memory device(s) that are remote from the autonomous vehicle 102.

The computing device(s) 129 can also include a communication interface 509 used to communicate with one or more other system(s) on-board the autonomous vehicle 102 and/or a remote computing device that is remote from the autonomous vehicle 102 (e.g., of remote computing system 510). The communication interface 509 can include any circuits, components, software, etc. for communicating with one or more networks (e.g., 520). In some implementations, the communication interface 509 can include for example, one or more of a communications controller, receiver, transceiver, transmitter, port, conductors, software, and/or hardware for communicating data.

In some implementations, the vehicle computing system 106 can further include a positioning system 512. The positioning system 512 can determine a current position of the autonomous vehicle 102. The positioning system 512 can be any device or circuitry for analyzing the position of the autonomous vehicle 102. For example, the positioning system 512 can determine position by using one or more of inertial sensors, a satellite positioning system, based on IP address, by using triangulation and/or proximity to network access points or other network components (e.g., cellular towers, WiFi access points, etc.) and/or other suitable techniques. The position of the autonomous vehicle 102 can be used by various systems of the vehicle computing system 106.

The network(s) 520 can be any type of network or combination of networks that allows for communication between devices. In some embodiments, the network(s) can include one or more of a local area network, wide area network, the Internet, secure network, cellular network, mesh network, peer-to-peer communication link, and/or some combination thereof and can include any number of wired or wireless links. Communication over the network(s) 520 can be accomplished, for instance, via a communication interface using any type of protocol, protection scheme, encoding, format, packaging, etc.

The remote computing system 510 can include one or more remote computing devices that are remote from the vehicle computing system 106. The remote computing devices can include components (e.g., processor(s), memory, instructions, data, etc.) similar to that described herein for the computing device(s) 129. Moreover, the remote computing system 510 can be configured to perform one or more operations of an operations computing system.

Computing tasks discussed herein as being performed at computing device(s) remote from the vehicle can instead be performed at the vehicle (e.g., via the vehicle computing system), or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implements tasks and/or operations can be performed sequentially or in parallel. Data and instructions can be stored in a single memory device or across multiple memory devices.

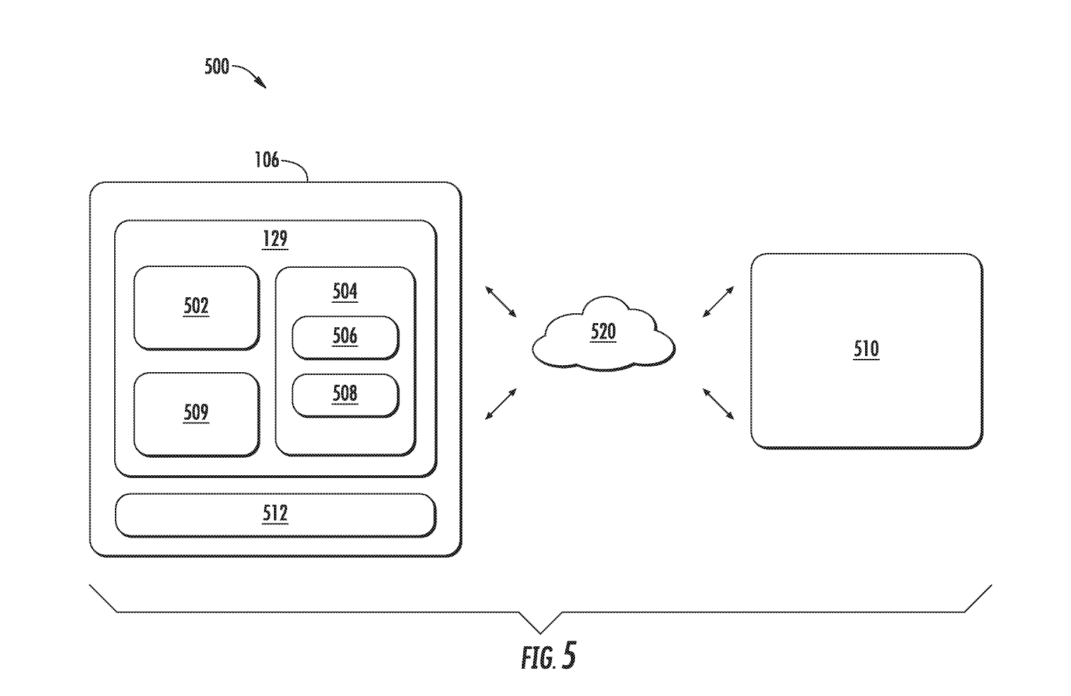

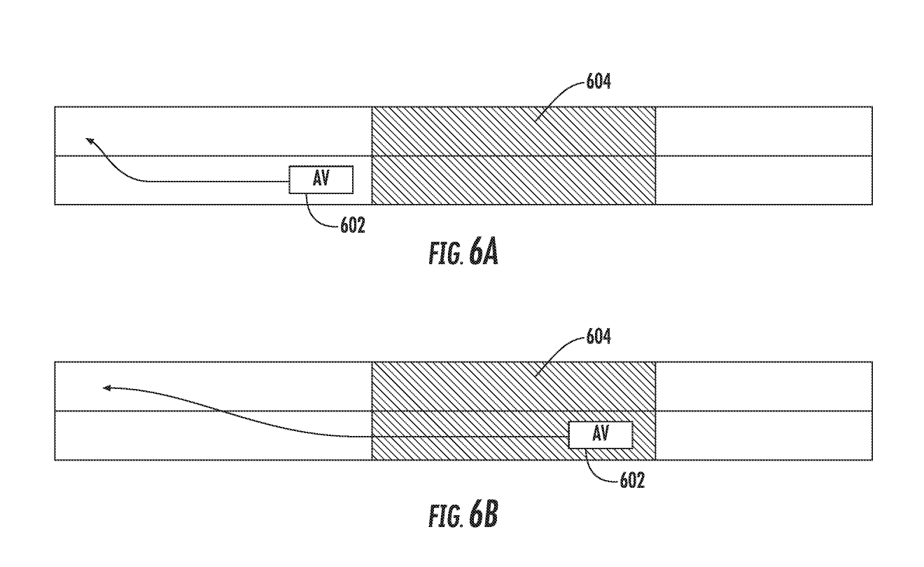

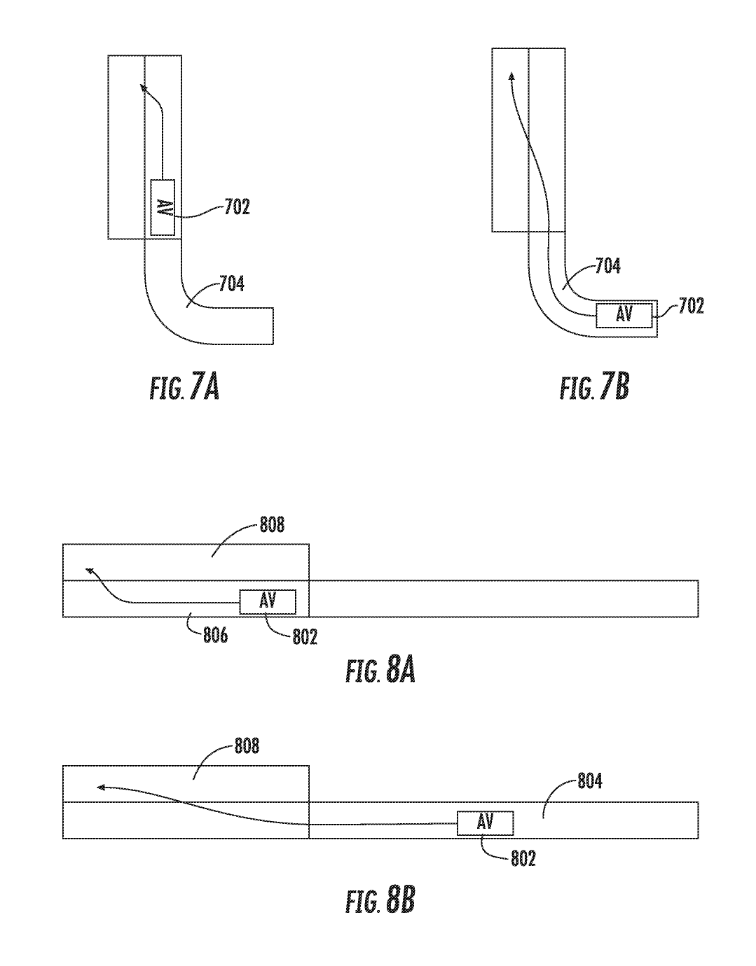

In some implementations, the initiation of a lane change plan may not occur until the autonomous vehicle is adjacent to the area that the autonomous vehicle is intending to move into (as illustrated in FIGS. 6A, 7A, and 8A). In some implementations, the autonomous vehicle may begin a lane change plan before the autonomous vehicle is adjacent to the intended or target lane change area. For example, the autonomous vehicle may begin the first phase of a lane change plan while the autonomous vehicle is approaching the target area where the lane change will occur and before the autonomous vehicle actually is adjacent to the target lane area that the autonomous vehicle will move into, such as where the autonomous vehicle will change lanes after crossing through an intersection (as illustrated in FIG. 6B), after making a turn (as illustrated in FIG. 7B), or into a upcoming new lane (as illustrated in FIG. 8B). In such situations, by initiating the lane change plan prior to being adjacent to the intended lane change area, the autonomous vehicle can implement smoother lane changes that can improve safety as well as the comfort level of the vehicle occupants.

FIG. 6A depicts a block diagram of a first example of lane change timing for a lane change that is to be completed after crossing an intersection according to example embodiments of the present disclosure. As illustrated in FIG. 6A, where an autonomous vehicle 602 intends to change lanes after crossing through an intersection 604, in some implementations, the lane change planning and execution may not be initiated until the autonomous vehicle 602 has completely crossed through the intersection 604 (e.g., is out of the intersection 604). For example, all phases of the lane change (such as illustrated in FIG. 4, for example) are not initiated and completed until the autonomous vehicle 602 has crossed completely through the intersection 604.

FIG. 6B depicts a block diagram of a second example of lane change timing for a lane change that is to be completed after crossing an intersection according to example embodiments of the present disclosure. As illustrated in FIG. 6B, where an autonomous vehicle 602 intends to change lanes after crossing through an intersection 604, in some implementations, the autonomous vehicle 602 may initiate the lane change plan (e.g., the first phase of the lane change) while the autonomous vehicle 602 is in the intersection 604 as opposed to initiating the lane change plan only after crossing completely through the intersection 604, such that the autonomous vehicle may complete the lane change more smoothly after crossing through the intersection.

FIG. 7A depicts a block diagram of a first example of lane change timing for a lane change that is to be completed after an upcoming turn according to example embodiments of the present disclosure. As illustrated in FIG. 7A, where an autonomous vehicle 702 intends to change lanes after completing a turn 704, in some implementations, the lane change planning and execution may not be initiated until the autonomous vehicle 702 has completed the turn 704. For example, all phases of the lane change (such as illustrated in FIG. 4, for example) are not initiated and completed until the autonomous vehicle 702 has completed the turn 704.

FIG. 7B depicts a block diagram of a second example of lane change timing for a lane change that is to be completed after an upcoming turn according to example embodiments of the present disclosure. As illustrated in FIG. 7B, where an autonomous vehicle 702 intends to change lanes after completing a turn 704, in some implementations, the autonomous vehicle 702 may initiate the lane change plan (e.g., the first phase of the lane change) while the autonomous vehicle 702 is in the turn 704 as opposed to initiating the lane change after completing the turn 704, such that the autonomous vehicle may complete the lane change more smoothly after completing the turn.

FIG. 8A depicts a block diagram of a first example of lane change timing for a lane change into an upcoming new lane (e.g., a new lane that starts ahead of the current vehicle position) according to example embodiments of the present disclosure. As illustrated in FIG. 8A, where an autonomous vehicle 802 intends to change lanes into an upcoming new lane 808, in some implementations, the lane change planning and execution may not be initiated until the autonomous vehicle 802 is adjacent to the new lane 808 (e.g., in current lane segment 806). For example, all phases of the lane change (such as illustrated in FIG. 4, for example) are not initiated and completed until the autonomous vehicle 802 is adjacent to the new lane 808.

FIG. 8B depicts a block diagram of a second example of lane change timing for a lane change into an upcoming new lane according to example embodiments of the present disclosure. As illustrated in FIG. 8B, where an autonomous vehicle 802 intends to change lanes into an upcoming new lane 808, in some implementations, the autonomous vehicle 802 may initiate the lane change plan (e.g., the first phase of the lane change) while the autonomous vehicle 802 is in current lane segment 804, before the upcoming new lane 808 begins, as opposed to waiting to initiate the lane change until after the autonomous vehicle 802 is adjacent to the new lane 808, such that the autonomous vehicle may complete the lane change more smoothly upon coming adjacent to the new lane.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method for executing a lane change in an autonomous vehicle comprising:
obtaining, by a computing system comprising one or more computing devices, an indication of an obstacle ahead of the autonomous vehicle in a current lane;
obtaining, by the computing system, an indication that the autonomous vehicle is likely to be queued behind the obstacle if staying in the current lane;
determining, by the computing system, that a lane change can be executed by the autonomous vehicle to move around the obstacle; and
in response to determining that the lane change can be executed by the autonomous vehicle to move around the obstacle, generating a motion plan that executes the lane change.

2. The computer-implemented method of claim 1 wherein the indication of the obstacle comprises an indication that the obstacle is not expected to flow with traffic.

3. The computer-implemented method of claim 1 wherein the indication that the autonomous vehicle is likely to be queued behind the obstacle comprises an indication that there is not enough space to pass the obstacle within boundaries of the current lane.

4. The computer-implemented method of claim 1 wherein determining that the lane change can be executed comprises determining that there is a minimum amount of distance in front of and behind the autonomous vehicle in an adjacent lane with respect to one or more other objects in the adjacent lane.

5. The computer-implemented method of claim 1 wherein determining that the lane change can be executed comprises determining that the lane change will not require an aggressive response by the autonomous vehicle.

6. The computer-implemented method of claim 1 wherein the obstacle comprises a parked vehicle or a stopped vehicle in the current lane.

7. The computer-implemented method of claim 1 further comprising:
determining, by the computing system, whether the autonomous vehicle should return to an original lane after passing the obstacle; and
in response to determining that the autonomous vehicle should return to the original lane, generating a motion plan that executes a return lane change.

8. An autonomous vehicle comprising:
a vehicle computing system comprising:
one or more processors; and
one or more memories including instructions that, when executed by the one or more processors, cause the one or more processors to perform operations, the operations comprising:
obtaining an indication of an obstacle ahead of the autonomous vehicle in a current lane;
obtaining an indication that the autonomous vehicle is likely to be queued behind the obstacle if staying in the current lane;
determining that a lane change can be executed by the autonomous vehicle to move around the obstacle;
in response to determining that the lane change can be executed by the autonomous vehicle to move around the obstacle, generating a motion plan that executes the lane change; and
providing one or more control signals to one or more vehicle controls to implement the motion plan.

9. The autonomous vehicle of claim 8 wherein the indication of the obstacle comprises an indication that the obstacle is not expected to flow with traffic.

10. The autonomous vehicle of claim 8 wherein the indication that the autonomous vehicle is likely to be queued behind the obstacle comprises an indication that there is not enough space to pass the obstacle within boundaries of the current lane.

11. The autonomous vehicle of claim 8 wherein determining that the lane change can be executed comprises determining that there is a minimum amount of distance in front of and behind the autonomous vehicle in an adjacent lane with respect to one or more other objects in the adjacent lane.

12. The autonomous vehicle of claim 8 wherein determining that the lane change can be executed comprises determining that the lane change will not require an aggressive response by the autonomous vehicle.

13. The autonomous vehicle of claim 8 wherein the obstacle comprises a parked vehicle or a stopped vehicle in the current lane.

14. The autonomous vehicle of claim 8, the operations further comprising:
determining whether the autonomous vehicle should return to an original lane after passing the obstacle;
in response to determining that the autonomous vehicle should return to the original lane, generating a second motion plan that executes a return lane change; and
providing one or more control signals to one or more vehicle controls to implement the second motion plan.

15. A computing system comprising:
one or more processors; and
one or more memories including instructions that, when executed by the one or more processors, cause the one or more processors to perform operations, the operations comprising:
obtaining an indication of an obstacle ahead of an autonomous vehicle;
obtaining an indication that the autonomous vehicle is likely to be queued behind the obstacle if staying in a current lane;
determining that a lane change can be executed by the autonomous vehicle to move around the obstacle;
in response to determining that the lane change can be executed by the autonomous vehicle to move around the obstacle, generating a motion plan that executes the lane change; and
providing one or more control signals to implement the motion plan.

16. The computing system of claim 15 wherein the indication of the obstacle comprises an indication that the obstacle is not expected to flow with traffic.

17. The computing system of claim 15 wherein the indication that the autonomous vehicle is likely to be queued behind the obstacle comprises an indication that there is not enough space to pass the obstacle within boundaries of the current lane.

18. The computing system of claim 15 wherein determining that the lane change can be executed comprises determining that there is a minimum amount of distance in front of and behind the autonomous vehicle in an adjacent lane with respect to one or more other objects in the adjacent lane.

19. The computing system of claim 15 wherein determining that the lane change can be executed comprises determining that the lane change will not require an aggressive response by the autonomous vehicle.

20. The computing system of claim 15, the operations further comprising:
determining whether the autonomous vehicle should return to an original lane after passing the obstacle;
in response to determining that the autonomous vehicle should return to the original lane, generating a second motion plan that executes a return lane change; and
providing one or more control signals to one or more vehicle controls to implement the second motion plan.
